(19) United States
(12) Patent Application Publication
(10) Pub. No.: US 2020/0265541 A1
(43) Pub. Date: Aug. 20, 2020

(54) Method and Plant for Parts Logistics

(71) Applicant: RSL LOGISTIK GMBH & CO. KG, Landsberg/Lech (DE)

(72) Inventor: Rolf Schoenenberger, Landsberg am Lech (DE)

(21) Appl. No.: 16/347,349

(22) PCT Filed: Nov. 8, 2017
(86) PCT No.: PCT/EP2017/078520

§ 371 Date: May 3, 2019

(30) Foreign Application Priority Data
Nov. 8, 2016 (DE) 10 2016 121 315.2

(51) Int. Cl. G06Q 50/28; G06Q 30/00; G06Q 10/06; G06K 19/06; G05B 19/042; G01C 21/20

(52) U.S. Cl. CPC G06Q 50/28; G06Q 30/0185; G06Q 10/06395; G06Q 10/30; G05B 19/042; G01C 21/206; G06K 19/06028

(57) ABSTRACT

A method for processing, tracking, and distribution of items in a plant in which a plurality of processes can be performed includes tagging each individual item with a unique identifier. For each individual item, the method identifies a customized career path that includes a plurality of processes in a defined sequence. The method includes passing each individual item through the customized career path identified for each individual item wherein the logistics of moving the individual item between processes is triggered by the processes in the customized career path.

### TECHNICAL FIELD

The present invention relates to a method and a plant for the logistics of parts, in particular for the processing, tracking, and distribution of parts in a plant.

### PRIOR ART

A method of the generic type is known from the prior art, in which a plurality of parts, for example, letters, packages, or boxes, can be transported, processed, sorted, and routed to the outbound logistics with the aid of conventional material handling. The “flow rate”, such as parts per hour, is frequently of primary importance. The individual part is not taken into account in this case.

### BRIEF OBJECTS AND SUMMARY OF THE INVENTION

The problem addressed by the present invention is therefore that of conceiving and then implementing the operational processes and the logistics on the basis of the part, i.e., the object to be handled, with the aid of a customization of the parts.

The problem is solved using a method and a plant having the features described herein.

In the method according to the invention for the logistics of parts, in particular for the processing, tracking, and distribution of parts in a plant, each individual part is tagged as a unique specimen. Each individual part passes through processes in the course of a customized career path. The logistics of the individual part is triggered by the necessary processes. The career path is understood to be, for example, the custom modification of the part while it is located in the plant. Thus, for example, in the case of damaged or dirty, used parts, a step-by-step repair or cleaning can take place, and the part can be improved or modified in this way. According to the invention, the processes that are necessary for the individual part are identified and the part is transported accordingly to appropriate stations, so that the processes can be carried out. The logistics of the part therefore takes place depending on the unique condition of the part. For example, some parts may need to be steam cleaned, followed by drying followed by mechanical scrubbing, while the condition of other parts may call for a different sequence of operations or additional or fewer operations in the sequence. Each part therefore travels a customized route in the plant as a unique specimen until it has completed a career or a development or a modification which makes it suitable for a further action, for example, storage or commissioning.

It is advantageous when the logistics of the individual part takes place depending on the existing and/or missing properties of the part and/or the required supplementation of its properties. The logistics is therefore customized for each part, which is handled as a unique specimen.

It is particularly advantageous when necessary processes are, for example, in particular, the identification and/or the supplementation of properties of the individual part and/or the commissioning, along with further parts, if necessary, of the individual part in order to fulfill orders. The part therefore evolves along its customized career. The customized career path of the individual part is the modification of the condition of the part and the processes necessary for modifying the condition of the part.

It is advantageous when the individual part is connected/married to an article carrier, in particular a trolley, which is equipped with a read and/or write element, in particular a barcode or transponder, whereby the individual part becomes a unique specimen. The trolley or the article carrier is therefore utilized for the unique identification of the goods.

It is advantageous when an open data record for each read and/or write element is created or generated in a database associated with the plant, and the data record is linked to an electronically writable, custom data record for each part. The piece of goods or the part is uniquely identified in the data record with respect to its existing properties or its missing properties. As soon as a property of the part changes, the data record is updated accordingly.

It is very particularly advantageous when the individual part is inspected for the presence of information, such as the part number and/or the part description, and/or is investigated for the presence of predetermined properties, for example, the condition of the part, and existing or ascertained properties are entered into the data record.

It is advantageous when the individual part is routed to a uniquely determined process chain, for example, for returned parts, or when properties of the parts, such as color, shape, or size, up to the identification of the part, for example, a water bottle or an 0.5-liter, filled cola bottle, are manually or automatically ascertained at workstations, in particular by photographing parts, for example, within and/or outside the plant. Therefore, a type of inventory of the part is taken, whereby properties to be added or to be modified can be ascertained, and the required career path of the individual part can be determined.

It is also advantageous when at least one property is added to the individual part at least one workstation, and this added property is entered into the data record. As a result, the part evolves and the data record is and can be shipped.

It is advantageous when the individual part is subjected to a quality inspection, in particular before being stored and/or warehoused in the plant. Therefore, the existing/missing properties of the part can be identified and entered into the data record.

It is advantageous when the individual part, after the addition of the property/properties at the workstations, or after it has been determined that no further property is to be added, is routed to a holding zone, a buffer, or a warehouse. Therefore, the part can be called up, as necessary, for the next process.

It is advantageous when, given the presence or absence of certain properties, the individual part is routed to a warehouse, from which the individual part is sold on-line or via a retail business.

It is advantageous when, in the event that less important properties or a small number of properties are missing, the individual part is routed to a wholesale warehouse, from which the individual part is sold to a wholesale business.

It is advantageous when, in the event that important properties or a large number of properties are missing, the individual part is routed to a recycling warehouse, from which the individual part is routed to a recycling process or any other type of reclamation process.

Due to the evaluation of the properties of the part, an assignment can therefore be made with respect to the further usability of the part.

It is advantageous when the individual parts are transported on article carriers, in particular on trolleys, which are equipped with the read and/or write element, in particular a barcode or transponder, the individual parts being attached to the article carrier, for example, being clamped or hung on hangers, or being placed, for example, in pouches or bags, mesh baskets, or trays, on the article carrier, and the individual parts comprise a goods label or have existing properties, wherein the article carriers and the parts connected thereto are handled as individual unique specimens. The parts and the article carriers can therefore be “married” in the database and the data record, so that the part becomes a unique specimen.

It is advantageous when the existing properties are stored in a data memory with the aid of a coding of the individual part and, if necessary, are assigned to the coding of the individual article carrier. The present properties of the part are then connected to the article carrier and can be easily tracked.

It is advantageous when each article carrier can be identified, in particular with the aid of a scanner or an RFID reader, and guided and steered through the plant to the workstations in a targeted manner. The scanner or the RFID reader is preferably installed in a fixed location (each one at a certain location in the plant) and, from there, can communicate with the database; in particular, the scanner or RFID reader can

a) report which article carrier has arrived at which scanner, and

b) obtain, for example, in the variable data record of this article carrier, the target address for the next destination (the customer wants, for example, delivery by a certain shipping provider, or the quality inspection determines that a button needs to be sewn on→destination: sewing station. etc.)

at this identifying the properties of the part or even only the individual part per se on the basis of the barcode or the readable and writable RFID chip, and releasing the direct further route of the part and its article carrier in the transport system. As a result, a separate logistics is created for the part depending on its unique properties. The scanner or the RFID reader is therefore preferably located in the proximity of a switch of the transport system and is capable of activating the switch, as necessary. The scanner or the RFID reader can also be provided, of course, at another point and can activate one or more switches, according to the part and its article carrier to be moved, from a greater distance. The scanner or the RFID reader can therefore become a decision point. Communication takes place with the database or a variable data record (and, therefore, with the connected part) per trolley.

It is advantageous when, at the workstations, information regarding the present properties of the individual part is gathered and the task in the process chain at this workstation is displayed and, after the individual part has been processed, all information that is important or relevant for this part can be electronically stored in the data record. At the workstation, the part can therefore be uniquely processed and can be further developed in terms of its career. After the processing, the data record is updated.

It is advantageous when the further transport route of the individual part is determined depending on the present properties of the individual part and the location of the individual part. This can take place, for example, on the basis of the identification with the aid of a scanner and at the appropriate direction of a control system.

It is advantageous when the further transport route of the individual part is determined according to a current capacity utilization of the workstations, The part can then be transported to another workstation, at which capacities are available, even when another property of the part is added there. The career of the part can therefore be developed uniquely and depending on the capacity utilization of the plant, Alternatively, the part can also be brought into a buffer store.

It is advantageous when the individual part is dynamically stored in the holding areas and/or in the warehouse zones and is commissioned as quickly as is reasonably possible.

It is advantageous when the individual parts are transported on article carriers, in particular, hanging on trolleys, wherein all the article carriers are identified as individual unique specimens with the aid of a read and/or write element, in particular, a barcode or RFID chip.

The individual parts can be, for example, returned parts or used textiles. In this case, it is advantageous when the parts are inspected with respect to their condition and their further processing, and the identification as well as the condition are determined with the aid of the ascertained properties, and the necessary steps in the process chain are predefined.

It is advantageous when the presence of all buttons, the proper functioning of zippers, holes in the textiles, the source of the textiles, the size and/or general condition of the textiles are defined as properties and are entered in the custom data record.

The described method is utilized for processing, tracking, and distributing parts/goods having the following characteristics: each part is considered to be a unique specimen and, nevertheless, as a “mass phenomenon”. The part is processed, steered, and accompanied in a process-oriented manner.

An example for an application of the invention is an automotive supplier, which is to supply the production “just in time” and “just in sequence” for an assembly line for passenger cars from five manufacturers. Once every 1.5 minutes, the information for the next required vehicle is electronically transmitted. The parts are routed to production from a dynamic buffer containing over 30,000 parts and, additionally, over 10,000 parts in a connected static warehouse containing over 15,000 different part positions, so-called SKUs (stock keeping units). The time from this communication until the transfer at one or multiple transfer points is approximately 90 minutes.

According to the invention, a customization of the parts takes place: in an aircraft, the “boarding pass” plus the personal identification of the passenger are the “entry ticket”. The identification per part (which varies according to manufacturer) is customized via a database and the so-called “marriage” with numbered, “unique” trolleys, i.e., each part becomes a unique specimen. The data records of the individual parts can be totally different. There can even be parts without part numbers.

The basic idea is: The processes in the operation and the logistics are conceived on the basis of the part, i.e., the object. The object requires a certain handling in order to achieve its career, i.e., to become complete, and therefore travels a customized route in the plant. The part is identified, processed, and moved as a unique specimen.

The processes according to the invention are as follows: the piece of goods flows, similarly to traffic engineering, for example. High volume must be managed, interruptions/intersections must be successfully handled, and rights of way, main directions, and “green waves” are to be defined and configured. There are decision points. At the decision points, for example, scanners read a barcode or a transponder of the trolley. The scanners identify the piece of goods and specify the “destination” or further route to each part/trolley.

The career path of each part can be different. Although the parts are individuals, i.e., unique specimens, the objective in the plant is for the parts to exit the plant at the outbound logistics with a destination address.

The operating model is data-based: From the inbound logistics (loading the trolleys) to the outbound logistics, each part is accompanied, monitored, tracked, and steered as a unique specimen and is even brought “back on track” in the event of deviations (errors).

A particularity is the data management: one open data record per part, which is nearly arbitrarily expandable and modifiable.

The data management permits one open data record per part, in order to further characterize the “unique specimens”, as well as for the description thereof (for example, article number: define part: item, color, size), supplemented with an assessment, a valuation, a condition: new, used; 1^{st}/2^{nd} choice; production information of the part.

The data record contains, for example, three portions per part

a) unique barcode trolley+unique barcode part

b) IN part-, product-, process-oriented fields

Conclusion: Part is now qualified for shipment

c) OUT Shipment-oriented processes up to the point of exiting the operation, for example, packing, weighing . . . up to the point of loading the truck, etc.

Fields for outbound-goods information can be provided in the open data record: Assigning the part to an addressee/recipient: customer; supplier; special note before outbound delivery: for example, “value added services”; export documents, etc.

The plant includes, in particular, “holding buffer zones”, i.e., workstations having upstream and downstream rest areas (awaiting transport).

A returned-parts management can also be stored in the plant control system. In this case, a process chain is established, which can be dependent on the condition of the piece of goods, for example, “ok” for sale, repacking, chemically cleaning; part is only “second hand”, or sold by weight, or recycling.

With respect to the invention, customization is of primary importance. The perspective changes over time: at the inbound logistics, the part/product is of primary importance; at the outbound logistics, the recipient and his/her wishes are of primary importance.

The invention can be generally referred to as event-driven logistics or/and as well as mass production with lot size 1.

The process management takes place in such a way that, for example, scanners are present at decision points, which can specify or confirm the next destination.

A plant according to the invention is utilized for carrying out the above-described method. The plant comprises a control system, a database, and a suspension track including a plurality of article carriers, in particular trolleys, for accommodating parts. In addition, at least one workstation is provided, at which at least one property of a part is added. Each trolley is connected to a read and/or write element and, for each read and/or write element, an open data record is created/generated, which is linked to an electronically writable, custom data record per part. Each individual part is tagged as a unique specimen, wherein processes are assigned to each individual part by the control system in the course of a customized career path, and the logistics of the individual part is triggered by the necessary processes.

The workstation is advantageously equipped in such a way that at least one property can be added to the part.

It is advantageous when the existing, missing, and/or added property or properties are entered into the data record.

The method and object-based features according to the preceding description can be present individually or in any combination.

### BRIEF DESCRIPTION OF THE DRAWINGS

Further advantages of the invention are described in the following exemplary embodiments. Wherein:

FIG. 1 shows an example of a flow chart of the process management in a plant according to the invention,

FIG. 2 shows an assignment of properties of an part to a write/read element according to the data management according to the invention,

FIG. 3 shows an example of a material flow,

FIG. 4 shows an example of a layout of a first level, and

FIG. 5 shows an example of a layout of a third level.

### DESCRIPTION OF EXEMPLARY EMBODIMENTS OF THE INVENTION

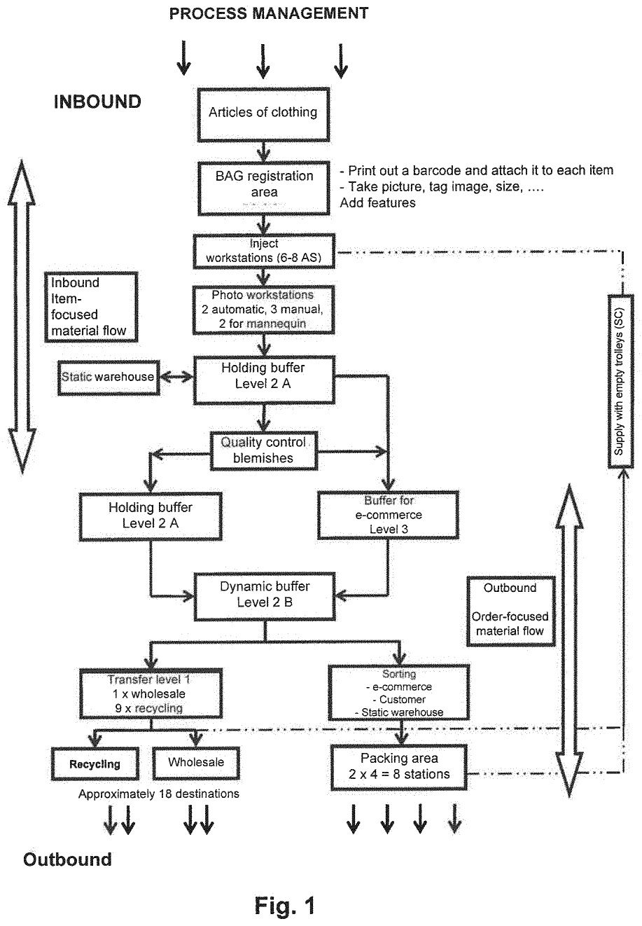

As schematically represented in FIG. 1, the procedure in the inbound area of the plant, in particular, takes place in a part-focused manner. Subsequently, in the outbound area of the plant, the order is of primary importance. Of course, it is also possible according to the invention, however, that the entire plant is run in such a way that the part is of primary importance.

The part, namely an article of clothing in this exemplary embodiment of FIG. 1, enters the plant and, first of all, is registered in the registration area. A barcode is printed out and attached to each part. A picture is also taken of the part and the various properties of the part are recorded. This recording can take place manually, i.e., a person inspects the part and enters the part's found or missing properties into the database with reference to the part and its barcode. The recording can also take place automatically, however, in that the photograph of the part is evaluated and the properties of the part are recorded and entered into the database.

After the tagging and registration of the parts, each part is placed on a separate trolley. The part is then transported to various workstations in order to complete any missing properties, as necessary, and the part is processed at the workstations. The workstations are differently equipped, for example, with a photostation once again, or automatic or manual devices for improving the properties of the part, i.e., for improving its career. The logistics of the particular part takes place in such a way that each individual part is tagged as a unique specimen, wherein each individual part passes through processes in the course of a customized career path, and the logistics of the individual part is triggered by the necessary processes. The individual part is moved to the individual workstations depending on the specific work it requires and the capacities of the workstations that are free at the moment that the part is available for transport to the particular workstation. The logistics of the individual part takes place depending on its existing and/or missing properties and/or the required supplementation of its properties. In so doing, each article carrier is identified, in particular with the aid of a scanner, and can be guided and steered through the plant to workstations in a targeted manner.

In the plant according to FIG. 1, after the properties of the part have been improved to the extent required or as much as possible at one of the workstations, then the part is routed to a holding buffer, from which it can be distributed to further stations. In the present case, the part is transported into a static warehouse, for example, when it is likely not to be required for a longer time. Alternatively, the part can be routed directly or via a quality control to a buffer zone provided for the sale of the part via e-commerce. As another alternative, the part is routed via the quality control to a holding buffer. When the part is to be commissioned, it ultimately enters a dynamic buffer and, from there, depending on the order and the part property, is routed to outbound points for the recycling of the part, the sale of the part in wholesale, or for packaging and sale in a retail business.

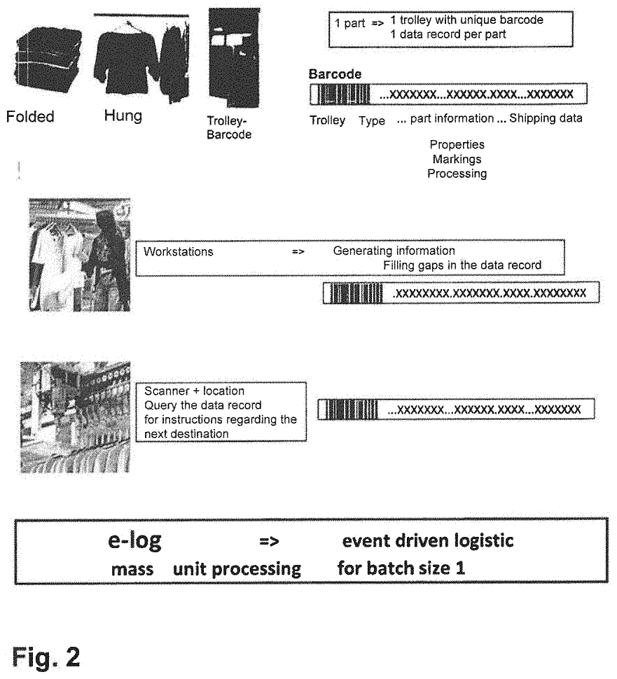

In FIG. 2, an embodiment variant of the data management of the present invention is schematically represented. A data record is assigned to a unique pair consisting of the trolley and the part. With the aid of a barcode, the trolley and, therefore, the part are identified by scanners. An open data record is created/generated for each read and/or write element in a database associated with the plant, and the data record is linked to an electronically writable, custom data record for each part. The part information regarding the properties of the part and, if necessary, shipping data are incorporated into the data record. These properties are supplemented in the course of the processing of the part at the workstations. Therefore, the gaps in the data record, which represent missing properties, are gradually filled. During a query of the present properties with the aid of a scanner, the further route to another workstation or into a certain warehouse can be determined, in order to close the remaining gaps. This is, therefore, event-driven logistics.

The piece of goods or the part is therefore moved according to a customized logistics. Given a large number of single, unique parts which are moved in a customized manner, a highly effective plant concept arises, on the basis of which even individual parts having very specific properties can be very quickly tagged, stored, and shipped.

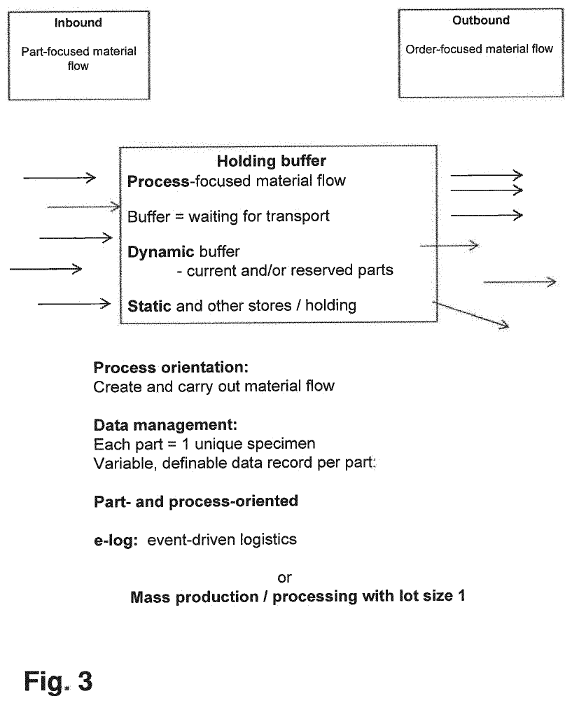

A material flow according to the invention is represented in FIG. 3. The individual parts are initially handled in a part-focused manner. Subsequently, for shipping or commissioning, the work is carried out in an order-focused manner. The order can also consist of multiple parts, or of only one part having very specific properties. The parts are repeatedly located in holding buffers, dynamic buffers, or static or dynamic stores until they arrive at a further processing station or the shipping area.

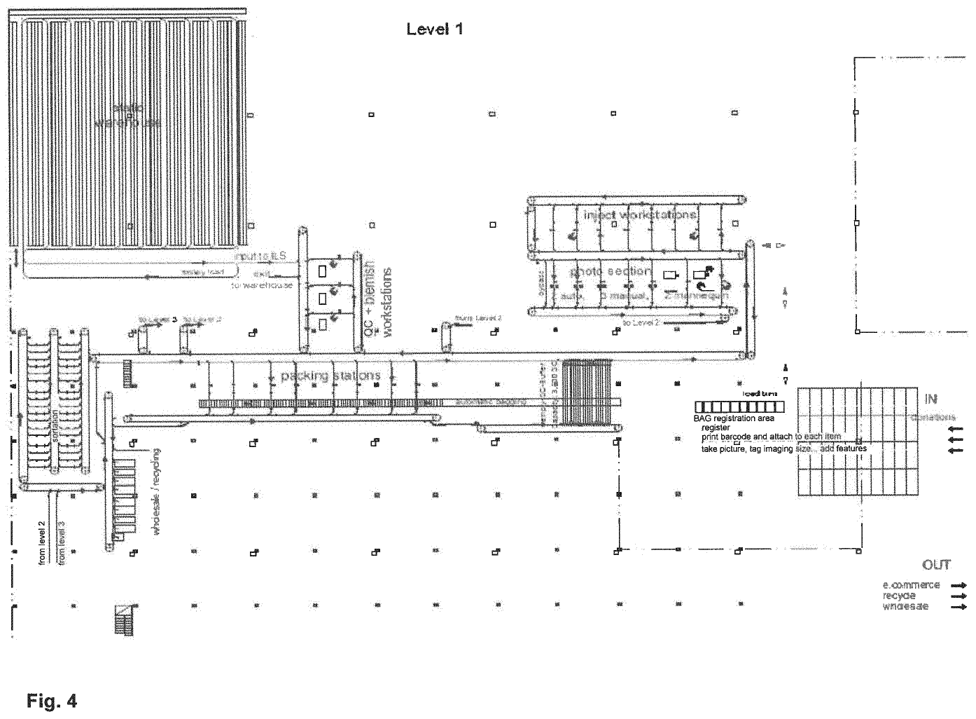

FIG. 4 schematically shows an example of a layout of a level of a plant. The layout contains suspension track rails, switches, workstations, and buffer zones, through which the individual part can pass and improve its career. Located in further levels (not shown) are further stores and buffer zones for trolleys including their parts, which are presently located in a waiting position. The trolleys are repeatedly detected by scanners and directed to their next position. In this next position, for example, a property of the part is improved, the part is inspected, or the part is stored or commissioned.

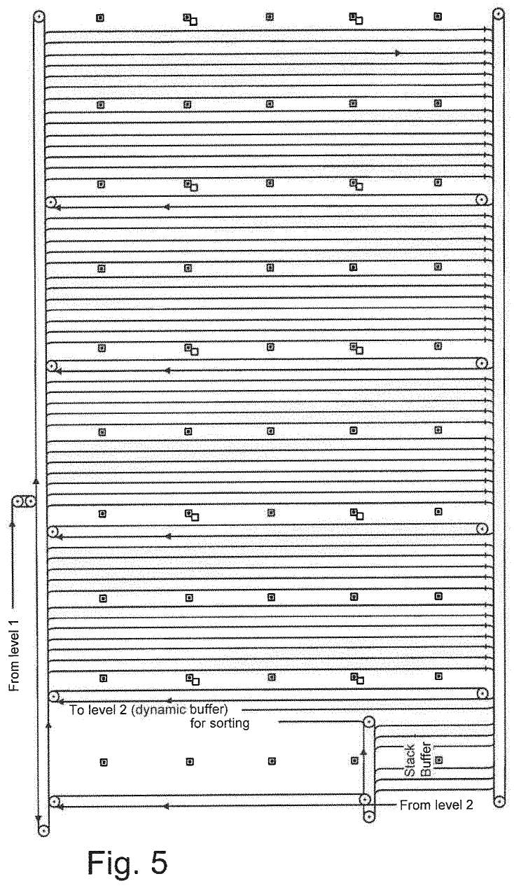

FIG. 5 schematically shows an upper level, for example, a third level of the layout of FIG. 4. In this level schematically shown in FIG. 5, the parts wait to be called; the parts wait chaotically or having been sorted according to a predetermined storage strategy. The parts can be marked, so that they are always filtered, for example, according to the “oldest release order part” (the part that has been in the filter process for the longest time) as the priority. The parts can be transported from the first level or from the second level into this third level for intermediate storage. When the parts are required for a commissioning, they are transported either into the second level for further filtering or sorting, or they are transported into the first level for sorting, or directly to the packing station.

The present invention is not limited to the represented and described exemplary embodiments. Modifications within the scope of the claims are also possible, as is any combination of the features, even if they are represented and described in different exemplary embodiments.

1. A method for the processing, tracking, and distribution of items in a plant, the method comprising the following steps: each individual item is tagged as a unique specimen, wherein choosing for each individual item a customized career path based on the sequence of processes to which the item is to be subjected in the plant, and the logistics of the individual item is determined based on the necessary processes in the customized career path, whereupon the indivisual item is routed through the plant in accordance with the logistics of the individual item.

2. The method as claimed in claim 1, wherein the logistics of the individual item takes place depending on its existing and/or missing properties and/or the required supplementation of its properties.

3. The method as claimed in claim 1, wherein the customized career path of the individual item is the modification of the condition of the item and the processes necessary for modifying the condition of the item, in particular, the identification and/or the supplementation of the properties of the individual item and/or the commissioning, along with further items, if necessary, of the individual item.

4. The method as claimed in claim 1, wherein the individual item is connected/married to an article carrier in the form of a trolley, which is equipped with a read and/or write element in the form of a barcode or transponder, whereby the individual item becomes a unique specimen.

5. The method as claimed in claim 1, wherein an open data record is created/generated for each read and/or write element in a database associated with the plant, and the data record is linked to an electronically writable, custom data record for each item.

6. The method as claimed in claim 1, wherein the individual item is inspected for the presence of information, such as the item number and/or the item description, and/or is investigated for the presence of predetermined properties, and existing or ascertained properties are entered into the data record.

7. The method as claimed in claim 1, wherein the individual item is routed to a uniquely determined process chain, for example, for returned items, or properties of the items, such as color, shape, or size, up to the identification of the item, for example, a water bottle or an 0.5-liter, filled cola bottle, are manually or automatically ascertained at workstations, in particular by photographing items, for example, within and/or outside the plant.

8. The method as claimed in claim 1, wherein at least one property is added to the individual item at at least one workstation, and this added property is entered into the data record.

9. The method as claimed in claim 1, wherein the individual item is subjected to a quality inspection, in particular before being stored and/or warehoused in the plant.

10. (canceled)

11. The method as claimed in claim 1, wherein, given the presence or absence of certain properties, the individual item is routed to a warehouse, from which the individual item is sold online or via a retail business, and/or, in the event that less important properties or a small number of properties are missing, the individual item is routed to a wholesale warehouse, from which the individual item is sold to a wholesale business, and/or, in the event that important properties or a large number of properties are missing, the individual item is routed to a recycling warehouse, from which the individual item is routed to a recycling process or any other type of reclamation process.

12. The method as claimed in claim 1, wherein the individual items are transported on article carriers, in particular on trolleys, which are equipped with the read and/or write element, in particular a barcode or transponder, the individual items being attached to the article carrier, for example, being clamped or hung on hangers, or being placed, for example, in pouches or bags, mesh baskets, or trays, on the article carrier, and the individual items comprise a goods label or have existing properties, wherein the article carriers and the items connected thereto are handled as individual unique specimens.

13. The method as claimed in claim 1, wherein the existing properties are stored in a data memory with the aid of a coding of the individual item and, if necessary, are assigned to the coding of the individual article carrier.

14. The method as claimed in claim 1, wherein each article carrier can be identified, in particular with the aid of a scanner, and guided and steered through the plant to workstations in a targeted manner.

15. The method as claimed in claim 1, wherein, at the workstations, information regarding the present properties of the individual item is gathered and the task in the process chain at this workstation is displayed and, after the individual item has been processed, all information that is important or relevant for this item can be electronically stored in the data record.

16. The method as claimed claim 1, wherein the further transport route of the individual item is determined depending on the present properties of the individual item and the location of the individual item, and/or according to a current capacity utilization of the workstations.

17. The method as claimed in claim 1, wherein the individual item is dynamically stored in the holding areas and/or in the warehouse zones and is commissioned as quickly as is reasonably possible.

18. The method as claimed in claim 1, wherein the items can be, for example, returned items or used textiles, which are inspected with respect to their condition and their further processing, and the identification as well as the condition are determined with the aid of the ascertained properties, and the necessary steps in the process chain are predefined.

19. The method as claimed in claim 1, wherein the presence of all buttons, the proper functioning of zippers, holes in the textiles, the source of the textiles, and the size and/or general condition of the textiles are defined as properties and are entered in the custom data record.

20. A plant for carrying out a method for the processing, tracking, and distribution of items, wherein the plant comprises:
a control system,
a database,
an overhead conveyor including a plurality of article carriers in the form of trolleys configured for accommodating items,
a workstation configured for adding at least one property of an item,
a respective read and/or write element connected to each respective trolley, and cot figured to create an open data record wherein each read and/or write element is linked to an electronically writable, custom data record for each item so that each individual item is tagged as a unique specimen,
wherein the control system is configured to assign processes to each individual item in the course of a customized career path so that the logistics of the individual item is triggered by the necessary processes.

21. (canceled)

22. (canceled)

23. A method for the processing, tracking, and distribution of a plurality of items in a plant having a plurality of processing stations within the plant, the method comprising the following steps:
affixing a unique tag to each one of the plurality of items or to a trolley that uniquely carries the respective one of the plurality of items;
identifying the type of each item that is uniquely tagged or carried by a uniquely tagged trolley;
for each respective uniquely tagged item or item carried by a uniquely tagged trolley, based on the type of the respective item, determining the processes to which the respective item is to be subjected in the plant;
based on the processes to which the respective uniquely tagged item or item carried by a uniquely tagged trolley is to be subjected in the plant and the availability of a station for performing each of the processes, determining a sequence for performing the processes that are to be applied in the plant to the respective uniquely tagged item or the item carried by a uniquely tagged trolley;
determining a customized career path according to the sequence for the respective uniquely tagged item or the item carried by a uniquely tagged trolley, wherein the customized career path constitutes the relative locations within the plant of the processing stations that are to be applied to the respective uniquely tagged item or the item carried by a uniquely tagged trolley;
using the tag to keep track of the location of the respective uniquely tagged item or the respective uniquely tagged trolley in the plant with respect to the processing stations in the customized career path of the respective uniquely tagged item or the item carried by a uniquely tagged trolley; and
moving the respective uniquely tagged item or the item carried by a uniquely tagged trolley between the processing stations in the customized career path in accordance with the sequence for performing the processes to be applied to the respective uniquely tagged item or the item carried by a uniquely tagged trolley.
